(19) United States
(12) Patent Application Publication
(10) Pub. No.: US 2022/0113136 A1
(43) Pub. Date: Apr. 14, 2022

(54) INTELLIGENT GEOGRAPHIC LOCATING SYSTEM BY IMAGING OF SKY, AND METHOD FOR GEOGRAPHIC LOCATING

(71) Applicant: Terradepth, Inc., Austin, TX (US)

(72) Inventors: Judson A. Kauffman, Austin, TX (US); Josef Wolfel, Austin, TX (US)

(21) Appl. No.: 17/497,096

(22) Filed: Oct. 8, 2021

Related U.S. Application Data
(60) Provisional application No. 63/089,639, filed on Oct. 9, 2020.

(51) Int. Cl. G01C 21/02; G06N 20/00; G01C 21/16; G01C 21/24

(52) U.S. Cl. CPC G01C 21/025; G01C 21/24; G01C 21/16; G06N 20/00

(57) ABSTRACT

An autonomous system for geographic locating may include a camera unit capable of capturing a present time image of a night sky, a processor operable to execute instructions accessible in memory, the processor capable of implementing a machine learning positioning algorithm comprising a finite sequence of instructions, the machine learning positioning algorithm comprising a training module operable in a training mode with a training dataset to train same, the machine learning positioning algorithm including a prediction module operable in a prediction mode with a live dataset to provide a prediction of an inferred geographic location of capturing the present time image.

### CROSS REFERENCE TO RELATED APPLICATIONS

This application is related and claims priority to U.S. Provisional Application 63/089,639 filed Oct. 9, 2020, which is incorporated by reference herein in entirety.

### FIELD OF THE INVENTION

This disclosure relates generally to systems and methods for geographic locating for navigation. The disclosure, more particularly, relates to systems and methods for geographic locating for navigation by reference to the sky.

### BACKGROUND OF THE INVENTION

Various systems, apparatus and methods exist for geographic locating in navigation, such as for use aboard transports such as ocean vessels and aircraft (hereinafter “transports”). Systems for geographic locating, for example, may include satellite positioning systems (“GPS”) using signals to and/or from satellites. Prior to the deployment of GPS systems, marine navigation of ships on the oceans often relied on the skilled use of a dual reflection instrument, the sextant, by mariners to navigate by reference to the horizon and objects in the sky (“celestial objects”). GPS systems are relatively simple to use, except where a GPS transceiver onboard the transport is inoperable or malfunctioning, or where GPS satellites are inoperable, such as due to malfunctions or intentional attack on the satellites or related infrastructure. Use of a sextant to navigate by reference to celestial objects requires knowledge of celestial objects, training in the use of star charts, is time intensive, generally cannot be performed in a reliable manner by an inexperienced person, and is subject to inadvertent introduction of measurement errors and calculation errors with potentially disastrous consequences for navigation and safety of the transport. Measurement errors and imprecisions, physical and sighting errors, recording errors, and calculation errors may be expected even with trained users. In view of the preceding, need exists for systems and methods for geographic locating in navigation, which are autonomous and precise, and do not require communication with GPS satellites, the use of a sextant, or specialized training.

Embodiments according to this disclosure include improved systems and methods for geographic locating in navigation, by capturing sky images. Embodiments according to this disclosure include improved systems and methods for geographic locating in navigation by capturing sky images, which may function when communications with GPS satellites are inoperable, do not require the use of a sextant or other complex instrument by a trained user, or other specialized training. For reasons stated above and for other reasons which will become apparent to those skilled in the art upon reading and understanding the present specification, there is a need in the art for improved systems methods for geographic locating in navigation.

### BRIEF DESCRIPTION OF THE INVENTION

The above-mentioned shortcomings, disadvantages and problems are addressed herein, as will be understood by those skilled in the art upon reading and studying the following specification. This brief description is a summary provided to introduce a selection of concepts in a simplified form that are further described below in more detail in the Detailed Description. This summary is not intended to identify key or essential features of the claimed subject matter. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In one aspect, embodiments according to this disclosure may include improved systems and methods for geographic locating in navigation, by capturing sky images. In an aspect, embodiments may include such improved systems and methods for geographic locating in navigation by capturing sky images, which are autonomous and precise, function when communications with GPS satellites are inoperable, do not require the use of a sextant or specialized instrument by a trained user, and do not require specialized training of users.

In an embodiment, an autonomous system for geographic locating in navigation may include a camera unit capable of capturing a present time image of the night sky. The present time image will include astronomical objects such as stars and planets located in the night sky. The system for geographic locating includes a processor and memory accessible by the processor. In an embodiment, the system may include an accelerometer and/or compass element and/or system clock. The processor may be capable of accessing, managing or controlling the accelerometer and/or compass element and/or to produce accelerometer output and/or compass output and/or clock. In an embodiment, the processor may be capable of relating or indicating the camera unit direction and/or attitude and/or yaw and/or clock time when capturing the present time image in relation to the accelerometer output and/or compass output. In an embodiment, the system thus may include by the camera unit, processor, accelerometer and compass thereof, providing the present time image with system image capture information including camera unit direction, camera unit attitude, camera unit yaw, and/or clock time for the present time image being captured.

The processor is capable of providing the present time image to a machine learning positioning algorithm. The machine learning positioning algorithm may be trained. In an embodiment, the machine learning positioning algorithm may be trained with a training set including a plurality of captured images of the night sky, wherein each of the captured images is associated with a corresponding known geographic image capture or viewing location (collectively, hereinafter “viewing location”). In an embodiment, the machine learning positioning algorithm may be trained with a training set including a plurality of captured images of the night sky, wherein each of the captured images is associated with a corresponding known geographic image capture viewing location and system image capture information including camera unit direction, camera unit attitude, camera unit yaw, and/or clock time for the captured image in the training set.

In an embodiment, the machine learning positioning algorithm may be trained with a training set including both a plurality of captured images of the night sky, wherein each of the captured images is associated with a corresponding known geographic image viewing location, and a stored star chart, stellar map, or digital sky survey. In an embodiment, the machine learning positioning algorithm, having been trained with the training set including the plurality of captured images of the night sky and each associated with a corresponding known geographic image viewing location, also may access and reference a stored star chart, stellar map, or digital sky survey (collectively, hereinafter “digital sky map”). The system for geographic locating may include the processor performing the machine learning positioning algorithm with the present time image to develop a correlation between the present time image and captured images of the night sky, the digital sky map, or both. The system for geographic locating may include inferring a present time viewing location for the present time image, by the processor performing the machine learning positioning algorithm with the correlation. In an embodiment, the system for geographic locating may provide an inferred present time viewing location for the present time image. The inferred present time viewing location for the present time image may be provided by the processor performing the machine learning positioning algorithm with the correlation. In an embodiment, the inferred present time viewing location for the present time image may be provided by the processor performing the machine learning positioning algorithm with the correlation and present time image. In an embodiment, the inferred present time viewing location for the present time image may be provided by the processor performing the machine learning positioning algorithm with the correlation and at least one captured image of the night sky associated with a corresponding known geographic image viewing location. In an embodiment, the inferred present time viewing location for the present time image may be provided by the processor performing the machine learning positioning algorithm with the correlation, the present time image, and at least one captured image of the night sky associated with a corresponding known geographic image viewing location. In an embodiment, the system for geographic locating may include inferring a present time viewing location for the present time image, by the processor performing the machine learning positioning algorithm with the correlation and a plurality of captured images of the night sky, wherein each of the captured images is associated with a corresponding known geographic image viewing location. In an embodiment, the present time image, and/or captured images of the night sky each associated with a corresponding known geographic image viewing location, and correlation may be provided to the machine learning positioning algorithm with the system image capture information including camera unit direction, camera unit attitude, camera unit yaw, and/or clock time.

Systems and methods of varying scope are described herein. These aspects are indicative of various non-limiting ways in which the disclosed subject matter may be utilized, all of which are intended to be within the scope of the disclosed subject matter. In addition to the aspects and advantages described in this summary, further aspects, features, and advantages will become apparent by reference to the associated drawings, detailed description, and claims.

### BRIEF DESCRIPTION OF THE DRAWINGS

The disclosed subject matter itself, as well as further objectives, and advantages thereof, will best be illustrated by reference to the following detailed description of embodiments of the device read in conjunction with the accompanying drawings, wherein:

FIG. 1 is a simplified block diagram of a system for geographic locating, in an exemplary embodiment;

FIG. 2 is a flowchart illustrating a machine learning positioning algorithm as shown generally in FIG. 1; and

FIG. 3 is a flowchart illustrating a method for geographic locating.

### DETAILED DESCRIPTION OF THE INVENTION

In the following detailed description, reference is made to the accompanying drawings which form a part hereof, and in which is shown by way of illustration specific embodiments which may be practiced. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. In view of the foregoing, the following detailed description is not to be taken as limiting the scope of the embodiments or disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

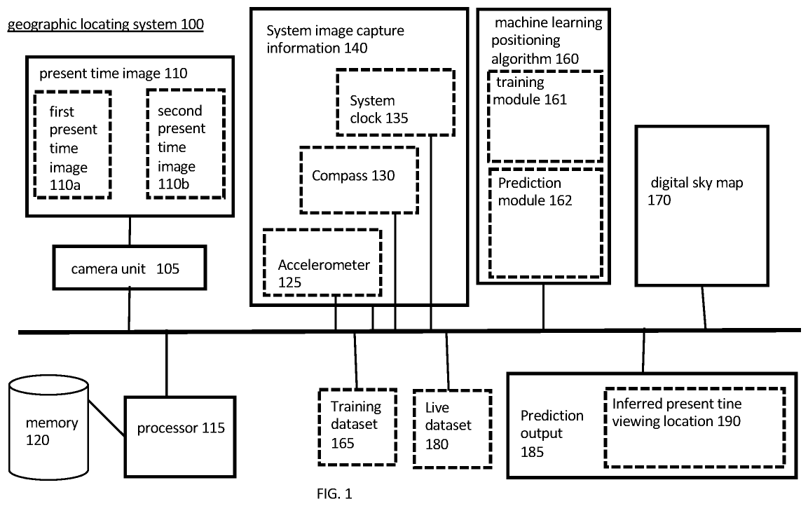

Illustrated in FIG. 1 is a simplified block diagram of an autonomous system 100 for geographic locating, in an exemplary embodiment. In an embodiment, system 100 for geographic locating in navigation may include a camera unit 105 capable of capturing a present time image 110 of the night sky. The present time image 110 will include astronomical objects such as stars and planets located in the night sky. In an embodiment, the present time image 110 may include a first present time image 110a of a first field of view of the night sky, and a second present time image 110b of a second field of view of the night sky. In an embodiment wherein the present time image 110 includes a first present time image 110a of a first field of view of the night sky, and a second present time image 110b of a second field of view of the night sky, the first field of view may differ at least in part from the second field of view by being taken at different first and second directions of the camera unit 105, at a common present time physical location. As used herein, a common present time physical location may include one physical location located within the range of travel of a movable transport, such as a ship, between two captures of a first present time image 110a and second present time image 110b which are taken in such immediate time period and location so as to constitute a common present time geographic location when determined by functioning of a system or method as herein disclosed. In other words, the two captures of a first present time image 110a and second present time image 110b during travel of a movable transport may be considered a common present time geographic location if so determined by functioning of a system or method as herein disclosed. It will be understood that the present time geographic location for the present time physical location is considered to be undetermined, unknown, indefinite or unconfirmed, and thus the present time geographic location is a result or product to be determined by functioning of system 100.

The system 100 for geographic locating includes a processor 115 and memory 120 accessible by the processor 115. The processor 115 is operable to execute instructions accessible in memory 120. In an embodiment, the system 100 may include an accelerometer 125 and/or compass element 130 and/or system clock 135. The processor 115 may be capable of accessing, managing or controlling the accelerometer 125 to produce accelerometer output. The processor 115 may be capable of accessing, managing or controlling the compass element 130 to produce compass output. The processor 115 may be capable of accessing, managing or controlling the system clock 135 to produce clock output. In an embodiment, the processor 115 may be capable of relating or indicating camera unit direction and/or attitude and/or yaw and/or clock time when capturing the present time image 110 in relation to the accelerometer output and/or compass output and/or clock output. In an embodiment, the system 100 thus may include by the camera unit 105, processor 115, accelerometer 125, compass 130 and/or system clock 135 being operable to provide the present time image 110 with accompanying system image capture information 140 including camera unit direction, camera unit attitude, camera unit yaw, and/or clock time for the present time image 110 being captured.

The processor 115 is capable of providing the present time image 110 to a machine learning positioning algorithm 160. The machine learning positioning algorithm 160 may include a training module operable in a training mode with a training data set, to train the machine learning positioning algorithm 160. The machine learning positioning algorithm 160 may include a prediction module operable in a prediction mode with a live data set, to provide a prediction. In an embodiment, the machine learning positioning algorithm 160 may be trained with a training set or dataset 165 including a plurality of captured images of the night sky, wherein each of the captured images is associated with a corresponding known geographic image capture viewing location. In an embodiment, the machine learning positioning algorithm 160 may be trained with a training set 165 which includes a plurality of captured images of the night sky, wherein each of the captured images is associated with a corresponding known geographic image capture viewing location and, in addition, is associated with system image capture information including camera unit direction, camera unit attitude, camera unit yaw, and/or clock time for the captured image.

As shown in FIG. 1, in an embodiment the machine learning positioning algorithm 160 may be trained with a training set 165 that includes both a plurality of captured images of the night sky, wherein each of the captured images is associated with a corresponding known geographic image viewing location, and a stored star chart, stellar map, digital sky survey, or digital sky map 170 (collectively, hereinafter “digital sky map”). The digital sky map 170 may include, for example, the Pan-STARRS Sky Survey (Space Telescope Science Institute, Baltimore, Md.), the Sloan Digital Sky Survey (SDSS.org or Skyserver Project), Google Sky (Google, Mountain View, Calif.) or Worldwide Telescope (American Astronomical Society, Washington, D.C.). In an embodiment, the machine learning positioning algorithm 160, having been trained with the training set including the plurality of captured images of the night sky and each associated with a corresponding known geographic image viewing location, also may access and reference the stored digital sky map 170.

The system 100 for geographic locating may include the processor 115 performing the machine learning positioning algorithm 160 with the present time image 110 to develop a machine learning model or correlation 175 (collectively, “correlation”) between the present time image 110 and pre-existing captured images 180 of the night sky each associated with a corresponding known geographic image viewing location, the digital sky map 170, or both. In an embodiment, the processor 115 may perform the machine learning positioning algorithm 160 with the present time image 110 and accompanying at least one of accelerometer output from accelerometer 125, compass output from compass 130 and clock output from system clock 135 for the present time image 110. In an embodiment, the processor 115 may perform the machine learning positioning algorithm 160 with the present time image 110 and accompanying system image capture information 140 including camera unit direction, camera unit attitude, camera unit yaw, and/or clock time for the present time image 110.

The system 100 for geographic locating may include a prediction output 185 including an inferred present time viewing location 190 for the present time image 110, by the processor 115 performing the machine learning positioning algorithm 160 with the correlation 175. In an embodiment, the system 100 for geographic locating may provide an inferred present time viewing location 190 for the present time image 110. The inferred present time viewing location 190 for the present time image 110 may be provided by the processor 115 performing the machine learning positioning algorithm 160 with the correlation 175. In an embodiment, the inferred present time viewing location 190 for the present time image 110 may be provided by the processor 115 performing the machine learning positioning algorithm 160 with the correlation 175 and present time image 110. In an embodiment, the present time image 110 may be accompanied by at least one of the accelerometer output from accelerometer 125, compass output from compass 130 and clock output from system clock 135 for the present time image 110. In an embodiment, the present time image 110 may be accompanied by at least one of the system image capture information 140 including camera unit direction of view, camera unit attitude, camera unit yaw, accelerometer output, compass output, and/or clock output for the present time image 110.

In an embodiment, the inferred present time viewing location 190 for the present time image 110 may be provided from performing the trained machine learning positioning algorithm 160 in the prediction mode, by the processor 115, with a live dataset 180 including the present time image 190, correlation 175, and at least one of the following: the digital sky map 170 and a captured image of the night sky associated with a corresponding known geographic image viewing location. In an embodiment, the live dataset 180 including a first present time image 110a and second present time image 110b may include system image capture information 140 including camera unit direction, camera unit attitude, camera unit yaw, accelerometer output, compass output, and/or clock output.

In an embodiment, the inferred present time viewing location 190 for the present time image 110 may be provided from performing the trained machine learning positioning algorithm 160 in the prediction mode, by the processor, 115, with live dataset 180 including a first present time image 110a and second present time image 110b, correlation 175, and at least one of the following: the digital sky map 170 and a captured image of the night sky associated with a corresponding known geographic image viewing location. In an embodiment, the live dataset 180 including a first present time image 110a and second present time image 110b may include system image capture information 140 including camera unit direction, camera unit attitude, camera unit yaw, accelerometer output, compass output, and/or clock output.

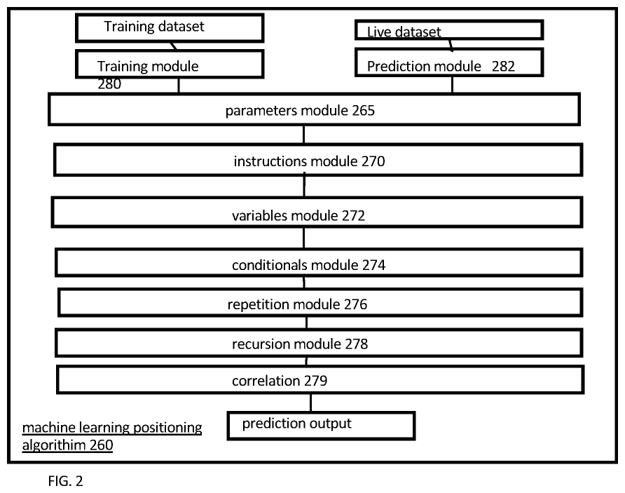

FIG. 2 is a flowchart illustrating details of machine learning positioning algorithm 260 in an exemplary embodiment. It will be understood that machine learning positioning algorithm 160 of system 100 shown in FIG. 1 may be substantially identical to machine learning positioning algorithm 260 shown in FIG. 2, except as otherwise described herein. Machine learning positioning algorithm 260 may be embodied in a finite sequence of instructions stored in memory, which are accessible and executable by a computing element such as a processor. Machine learning positioning algorithm 260 may include a parameters module 265 including named input parameters. Machine learning positioning algorithm 260 may include an instructions module 270 including task instructions. Machine learning positioning algorithm 260 may include a variables module 272 including values that may vary as the algorithm progresses. Machine learning positioning algorithm 260 may include a conditionals module 274 configured to perform selective decisions in relation to satisfaction of conditions. Machine learning positioning algorithm 260 may include a repetition module 276 configured to cause repeated execution of some task instructions until conditions are satisfied. Machine learning positioning algorithm 260 may include a recursion module 278 configured to perform recursive updating. Machine learning positioning algorithm 260 may include a trainable predictive model or correlation 279. The machine learning positioning algorithm 260 may include a training module 280 operable in a training mode with a training data set, to train the machine learning positioning algorithm 260. The machine learning positioning algorithm 260 may include a prediction module 282 operable in a prediction mode with a live data set, to develop or provide a prediction output including an inferred present time image viewing location for the present time image in the live dataset.

Referring to FIG. 2, in an embodiment, the machine learning positioning algorithm 260 by the training module 280 may receive a training dataset to be trained with the training dataset including a plurality of captured images of the night sky, and/or a digital sky map accessible from the training module 280. In a training dataset, each of the captured images may be associated with a corresponding known geographic image capture viewing location. In an embodiment, the machine learning positioning algorithm 260 by the training module 280 may be trained with the a training dataset which includes a plurality of captured images of the night sky, wherein each of the captured images is associated with a corresponding known geographic image capture viewing location and, in addition, is associated with system image capture information including camera unit direction, camera unit attitude, camera unit yaw, accelerometer output, compass output, and/or clock output for the present time image.

As shown in FIG. 2, in an embodiment, the machine learning positioning algorithm 260 may be trained by executing training module 280 with the training dataset that includes both a plurality of captured images of the night sky, wherein each of the captured images is associated with a corresponding known geographic image viewing location, and a stored digital sky map.

In an embodiment, the machine learning positioning algorithm 260 by the prediction module 282 may be implemented with a live dataset including the present time image to develop a correlation 279 between the present time image and pre-existing captured images of the night sky each associated with a corresponding known geographic image viewing location, the digital sky map, or both. In an embodiment, the machine learning positioning algorithm 260 by the prediction module 282 may be implemented with a live dataset including the present time image to develop correlation 292 between the present time image 290 and the digital sky map 170. In an embodiment, the machine learning positioning algorithm 260 by the prediction module 282 may be implemented with the live dataset 288 including the present time image 290 and the correlation 279 to develop or infer for the present time image, inferred system image capture information such as inferred camera unit direction, inferred camera unit attitude, inferred camera unit yaw, inferred clock time, and/or inferred horizon line for the present time image, by the processor performing the machine learning positioning algorithm 260 with the correlation 292. The machine learning positioning algorithm 260 by the prediction module 282 may be implemented with the live dataset including the present time image and the correlation 279 to develop or provide prediction output including an inferred present time viewing location for the present time image. In an embodiment, the machine learning positioning algorithm 260 by the prediction module 282 thereof, may be implemented to develop or provide the inferred present time viewing location for the present time image of the live dataset.

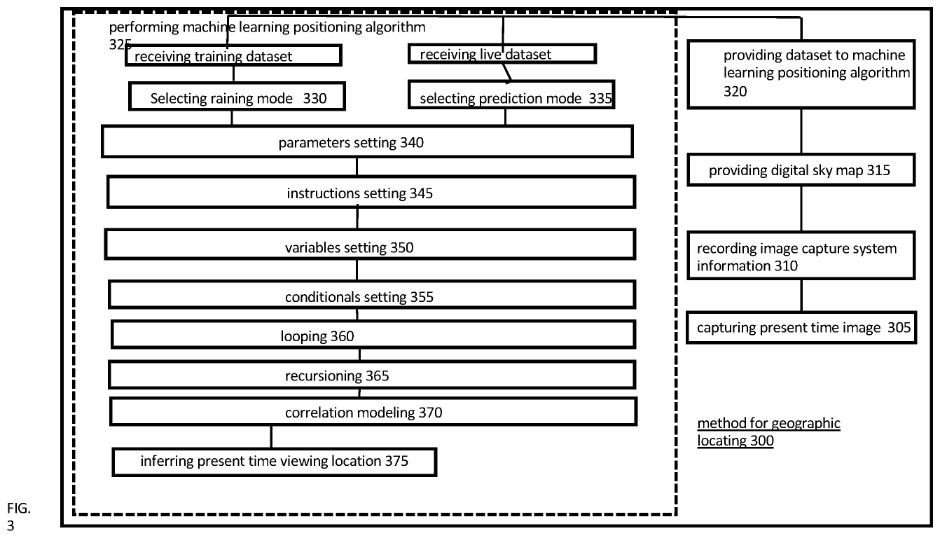

FIG. 3 is a flowchart illustrating a method 300 for geographic locating, in an embodiment. Method 300 may be performed, for example, by operation and functioning of system 100 as shown generally in FIG. 1. Method 300 includes capturing 305 a present time image of the night sky, with the camera unit, from an undetermined present time viewing location that is uncertain, undetermined or unconfirmed, and is to be determined by the method 300 using the present time image of the night sky. Thus, for example, the present time image of the night sky may be captured, with the camera unit, from a movable transport at sea and located at a present time physical location that is also an uncertain, undetermined or unconfirmed geographic location, i.e. the present time viewing location, that is to be determined by performing the method 300 using the present time image of the night sky.

Method 300 may include recording 310 image capture system information for the present time image. The image capture system information may include, for example, camera unit direction, camera unit attitude, camera unit yaw, accelerometer output, compass output, and/or clock output for the present time image. Method 300 may include providing 315 a digital sky map. The digital sky map may be accessed in the performing 325 of the machine learning positioning algorithm. Method 300 may include providing 320 a dataset to the machine learning positioning algorithm. The dataset may be a training dataset provided to the machine learning positioning algorithm via the training module when performing the machine learning positioning algorithm in the training mode. In the alternative, the dataset may be a live dataset provided to the machine learning positioning algorithm via the prediction module when performing the machine learning positioning algorithm in the prediction mode. Method 300 includes executing or performing 325 the machine learning positioning algorithm, by the processor executing the finite sequence of executable instructions that embody the algorithm. Executing or performing 325 the machine learning positioning algorithm may include executing or performing any of the following: parameters setting 340, instructions setting 345, variables setting 350, conditionals setting 355, looping 360, and recursioning 365. Executing or performing 325 the machine learning positioning algorithm will include correlation modeling 370. Executing or performing 325 the machine learning positioning algorithm also will include inferring 375 present time viewing location from the correlation modeling 370.

Embodiments as herein disclosed may provide improved geographic locating in navigation, by capturing sky images in an automated manner with low complexity. Embodiments may function in an autonomous and precise manner, may function when communications with GPS satellites are inoperable, function quickly without requiring the use of a sextant or specialized instrument by a trained user, and do not require specialized training of users.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above described embodiment, method, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein. Terminology used in the present disclosure is intended to include all environments and alternate technologies that provide the same functionality described herein.

What is claimed is:

1. An autonomous system for geographic locating, said system comprising:
a camera unit capable of capturing a present time image of a night sky;
a processor operable to execute instructions accessible in memory;
the processor capable of implementing a machine learning positioning algorithm comprising a finite sequence of instructions;
said machine learning positioning algorithm comprising a training module operable in a training mode with a training dataset, to train the machine learning positioning algorithm;
said machine learning positioning algorithm comprising a prediction module operable in a prediction mode with a live data set, to provide a prediction comprising an inferred geographic location of capturing the present time image.

2. An autonomous system for geographic locating according to claim 1, said system comprising:
the training set including a plurality of captured images of the night sky, each of the plurality of captured images associated with a corresponding known geographic image viewing location.

3. An autonomous system for geographic locating according to claim 1, said system comprising:
the training set including a stored digital sky map accessible for developing a correlation of the captured present time image in relation to at least one stored digital sky map subset.

4. An autonomous system for geographic locating according to claim 1, said system comprising:
the training set including at least one pre-existing captured image each associated with a corresponding known geographic image viewing location for developing a correlation of the captured present time image in relation to the at least one pre-existing captured image.

5. An autonomous system for geographic locating according to claim 4, said system comprising:
the training set including at least one pre-existing captured image each associated with a corresponding known geographic image viewing location for developing a correlation of the captured present time image in relation to a known geographic image viewing location corresponding to the at least one pre-existing captured image.

6. An autonomous system for geographic locating according to claim 1, said system comprising:
said live data set further comprising at least one of the following:
a digital sky map and a preexisting captured image of the night sky associated with a corresponding known geographic image viewing location.

7. An autonomous system for geographic locating according to claim 1, said system comprising:
an accelerometer operable to produce accelerometer output in relation to the camera unit.

8. An autonomous system for geographic locating according to claim 1, said system comprising:
a compass element operable to produce compass output in relation to the camera unit.

9. An autonomous system for geographic locating according to claim 1, said system comprising:
a system clock operable to produce clock output in relation to the camera unit.

10. An autonomous system for geographic locating according to claim 1, said system comprising: the processor capable of relating the present time image with system image capture information.

11. An autonomous system for geographic locating according to claim 10, said system comprising: said system image capture information for the present time image comprising at least one of the following: camera unit direction, camera unit attitude, camera unit yaw, and clock time.

12. An autonomous system for geographic locating according to claim 1, said system comprising:
the present time image comprising a first present time image of a first field of view of the night sky and a second present time image of a second field of view of the night sky.

13. A method for autonomous geographic locating, said method comprising:
first capturing, by a camera unit, a present time image of a night sky;
second capturing system image capture information for the present time image, the system image capture information comprising at least one of the following: camera unit direction, camera unit attitude, camera unit yaw, and clock time;
implementing, by a processor, a machine learning positioning algorithm comprising a finite sequence of instructions;
training, by a training module with a training dataset, said machine learning positioning algorithm in a training mode;
executing, by a prediction module of said machine learning positioning algorithm in a prediction mode with a live dataset comprising the present time image;
developing, by the prediction module of said machine learning positioning algorithm in said prediction mode with the live dataset comprising the present time image, a correlation of the present time image with at least one of the following:
a pre-existing captured image of the night sky, and
a stored digital sky map;
predicting, by a prediction module of said machine learning positioning algorithm in a prediction mode with the correlation, an inferred geographic location of capturing the present time image.

14. A method for autonomous geographic locating according to claim 13, said method comprising:
in said developing, accessing the stored digital sky map for developing the correlation of the captured present time image in relation to at least one stored digital sky map subset.

15. A method for autonomous geographic locating according to claim 13, said method comprising:
in the first capturing, the present time image comprising a first present time image of a first field of view of the night sky and a second present time image of a second field of view of the night sky.

16. A non-transitory computer-accessible medium having stored thereon computer-executable instructions for autonomous geographic locating, wherein, when a computer hardware arrangement executes the instructions, the computer hardware arrangement is configured to perform procedures comprising the method of claim 13.
